(19) United States
(12) Patent Application Publication
(10) Pub. No.: US 2015/0254581 A1
(43) Pub. Date: Sep. 10, 2015

(54) RIDESHARE SYSTEM AND METHOD TO FACILITATE INSTANT CARPOOLING

(71) Applicant: iCarpool, Inc., Issaquah, WA (US)

(72) Inventor: Amol Brahme, Issaquah, WA (US)

(21) Appl. No.: 14/633,271

(22) Filed: Feb. 27, 2015

Related U.S. Application Data
(60) Provisional application No. 61/947,731, filed on Mar. 4, 2014.

(51) Int. Cl. G06Q 10/02; G06F 17/30

(52) U.S. Cl. CPC G06Q 10/02; G06F 17/30864; G06F 17/30241

(57) ABSTRACT

A method of ridesharing to facilitate instant carpooling includes registering a first party with a ridesharing service, providing a unique identity to the first party upon the first party meeting an approval process, receiving, from the first party, information regarding a first route that comprises a plurality of first locations along a first path to be traveled in a first direction by a vehicle, receiving, from a second party, information regarding a second route that comprises a second location and a third location along a second path to be traveled in a second direction by a vehicle, receiving, from the first party, a first communication indicating that the first party is embarking within a predetermined amount of time to travel along the first route, determining, via a processor, whether the first route and the second route match, and upon determining a match, sending a second communication.

### FIELD OF INVENTION

The present disclosure is generally applicable in the field of ridesharing. More particularly, the present disclosure concerns facilitating instant carpooling in which drivers provide rides to riders on a per trip basis without requiring a longstanding pre-arrangement between the rider and the driver.

### BACKGROUND

A wide variety of stakeholders stand to benefit from ridesharing and experts agree ridesharing has several tangible and intangible benefits. Drivers may achieve cost savings and potentially reduced travel time by using high occupancy lanes. Riders may benefit from low cost transportation and increased mobility that may adjust better to their schedule, travel origin and destination. Employers may reduce parking costs. Employees may achieve higher productivity if they ride in a carpool as against driving, as driving is a complex activity that requires hand-eye coordination and consumes energy. Communities may benefit from reduced traffic on the roads and better air quality with lower greenhouse gases and pollutant levels. Yet, despite clear advantages at an individual and broader level, ridesharing has had limited success. According to the 2010 American Community Survey Highlights conducted by the US Census Bureau, less than 10% commuters carpooled to work, whereas over 70% commuters drove alone to work. This shows that the vast majority of commuters are choosing to drive alone instead of carpooling despite all the advantages associated with carpooling.

Numerous surveys have been conducted to find out what are the reasons that hinder a person from carpooling. Some of the problems that have been cited are listed below:

a) Flexibility—Carpools require two or more individuals to commit to a departure time and a travel plan well in advance of the actual travel. In today's global work culture each individual may encounter unpredictable work hours or may encounter dynamic changes in their schedule. Therefore, individuals find it hard to make longstanding commitments required for carpooling.

b) Reliability—If a carpool driver is unable to pick up the rider, then the rider may become stranded or may have to find out an alternate means of transport such as transit or taxi, which may take a longer time or may be expensive.

c) One Person Delays The Entire Group—A carpool has a fixed schedule. If one person in a carpool is late, others may have to wait and potentially everyone in the carpool may become late.

d) Coordination And Planning—It takes effort to coordinate with various potential carpool partners and plan on potential meeting places, times of journey, route, etc.

e) Privacy—Typically today's ridematching systems require users to provide their home and work address and provide matches based on these. Increasingly with the proliferation of information in the online world, users want to protect their privacy and the requirement of providing home or work address dissuades users from using services.

Current solutions that cater to carpooling are typically plagued by these problems. A field has emerged in the last few years and has been interchangeably referenced among various other terms as real-time ridesharing, dynamic ridesharing, dynamic carpooling, etc. Broadly, this field aims at carpooling on a per trip basis as against an agreement between two individuals over a longer period of time that may be weeks or months. However, solutions in this field are sub-optimal and have problems. For simplicity, this publication uses the term real-time ridesharing to describe the field. Generally, real-time ridesharing systems require a driver and a rider to establish contact prior to their meeting at the rider's location. This method is sub-optimal for several reasons. It requires both parties; the rider and the driver, to communicate with each other for each trip and the problem is compounded when multiple riders solicit rides from multiple drivers. For a typical commuter who wants to utilize real-time ridesharing, such communication has to happen two times every day, which is a lot of work.

Other issues come about in existing real-time ridesharing systems as the driver does not make pre-determined stops along the route where the driver has selected the stops. The driver may have to deviate from their regular route to pick up a rider at short notice. Such deviations add to the distance and time of travel for the driver. These deviations may be different on each trip and may cause different driving distance and time on each trip. A driver who is a typical commuter, who offers real-time rideshare on the way to work and on the way back from work, is unable to predict the time and distance associated with the trip to work and the trip back from work. In other words, the driver is unable to predict when the driver reaches work and when the driver reaches home. The problem is compounded as some deviations may lead the driver into a so-called trap:
The deviation may take the driver on a route that may involve one-ways, or roadways where the median strip which is the reserved area that separates opposing lanes of traffic is barricaded, such that returning back to the driver's original route may involve driving a longer distance than the driver expected;
The deviation may take the driver on to a busy local road with heavy traffic or multiple traffic lights such that returning back to the driver's original route may take a longer time than the driver expected;

The lack of pre-determined stops for the driver's trip implies the driver does not have any control in determining which deviations to the route are acceptable and where to pick-up riders. The rider may request the pick-up at a location that the driver may consider unsafe or inconvenient to stop. In addition, the driver may have to be distracted time and again for responding to ride requests or following driving directions to the rider's location. These distractions inconvenience drivers and may become a safety issue related to the task of driving.

The problems listed above multiply when one driver is providing a ride to two or more riders.

Some implementations of real-time ridesharing process a ride request from a rider and assign a driver to fulfill the ride request without letting either the driver or the rider or both to confirm their willingness to travel together with the other party. The lack of control about the travel partner may cause an unsatisfactory experience for users of such a system.

Some implementations, such as the casual carpooling in Washington D.C., allow anonymous riders to board vehicles driven by anonymous drivers. This aspect may create a safety issue as a rogue rider or a rogue driver could abuse such a system. The system generally does not provide a mechanism for riders to determine whether driver trips that are compatible to their trip needs are in progress. Therefore, a rider may not have enough information to decide on whether to go to a rideshare stop and wait for a ride or whether to utilize a different mode such as taxi or transit. A rider may go to a rideshare stop, but may end up waiting for an unknown period of time for a matching driver to come along. Similarly, a driver may go to a rideshare stop and not find any riders waiting at the stop, resulting in wasted time and effort. The implementations therefore do not allow for scaling up and are available only in limited “corridors” where the number of riders and drivers is high and where there is another mode of transport such as transit available nearby as a fallback option. Other problems come about with a lack of standards for fares, vehicle condition, driving record and driver history, etc. These problems and other needs are addressed by various embodiments and configurations of the present disclosure.

### SUMMARY

The present disclosure provides a ridesharing system that facilitates instant carpooling using a computer aided method. Drivers and riders register and go through an approval process before participation. A database of locations that serve as hubs for passenger transportation (stops) is maintained. Drivers create driver trips that are represented by an ordered set of stops and halt at stops to pick up or drop-off riders going their way. Riders find drivers going their way and choose to carpool with them for one trip on a first come first serve basis. Riders board the vehicle at a stop near their origin (pickup stop). Riders disembark the vehicle at a stop near their destination (drop-off stop). Riders are charged a fare using the distance between the pickup stop and the drop-off stop as a factor and a variable index based on the location of the rider as another factor. Drivers receive compensation that is proportional to the total fare charged to all the riders during the driver trip.

In one embodiment, a rideshare system is provided that facilitates instant carpooling, a type of carpooling in which drivers provide rides to riders on a per trip basis without requiring a longstanding pre-arrangement between the rider and the driver.

In one embodiment, a rideshare system uses a computer aided method that comprises the steps of:

maintaining a database of locations which may be referred to as stops, that may serve as hubs for passenger transportation in the rideshare system;

drivers and riders registering in the rideshare system and the driver, rider and the vehicle going through an approval process prior to participation in the carpool;

riders purchasing ride credits that are maintained in their account in the rideshare system;

providing riders with an identification card in the form of a physical card or a digital representation of their identity made available on their mobile device; for example, user profile stored on the phone or smart card that uses Radio-Frequency Identification (RFID);

providing drivers with mobile devices that have the capability to record rider information or read rider identification cards and record rider information or alternatively allowing drivers to use their personal mobile devices that have such capability; For example, smart phones that have a touch screen interface, Near Field Communications (NFC) and can read RFID contactless cards;

drivers creating driver trips in the rideshare system corresponding to the driver's travel plans wherein the driver can offer rides to one or more matching riders;

representing each driver trip as an ordered set of stops that is a subset of the stops in the database, wherein these stops indicate locations where the driver will stop and pickup or drop-off riders;

drivers using their mobile device to signal to the rideshare system a few minutes before beginning the driver trip to create a rideshare opportunity that lasts for the duration of the driver trip;

riders using their mobile device and providing information about their travel requirement including the origin and destination, where such travel requirement is immediate, and being presented with information about driver trips (rideshare opportunities) matching their travel requirement, where such information includes the vehicle license plate, vehicle color, make and model, number of empty seats available, driver ratings, estimated time of arrival and near real time location of the vehicle and allowing the rider to book their ride on a matching driver trip on a first come first served basis;

riders boarding the vehicle at a stop near their origin if the rider has booked their ride or on a first come first served basis and their identification card being used to record their boarding on the driver's mobile device;

riders disembarking the vehicle at a stop near their destination and their identification card being used to record their drop-off on the driver's mobile device;

the rideshare system calculating the fare for the rider using the distance between their pickup stop and their drop-off stop as a factor and a variable index based on their location as another factor and charging the fare to the rider's account;

riders rating their driver at the end of their trip;

drivers using their mobile device to signal to the rideshare system when the driver trip has ended;

drivers rating riders at the end of the trip;

the rideshare system compensating the driver in proportion to the total fare charged to all the riders during the driver trip.

Substantial improvements may be seen, such as:

1) All riders and drivers are approved members of the rideshare system and there are no anonymous riders or anonymous drivers. The rideshare system tracks each ride and can associate each ride with a unique rider account and a unique driver account. This aspect boosts safety and as a result, members can carpool in confidence.

2) Drivers and riders do not need to commit to a departure time. The driver can start the trip at any time. The rider can choose to depart when the rider needs a ride. The carpool occurs on each driver and rider's own schedule that may change for every trip they take. Thus, the rideshare system provides flexibility for both riders and drivers.

3) Drivers determine the stops for their trip in advance. This implies the driver has full control as to which deviations to the route are acceptable and where to pick-up riders. Issues that are seen where the pickup and drop-off are not at pre-determined stops such as safety concerns about the pickup location of the rider, the deviation causing a longer route or taking too much time are avoided. There are no unscheduled deviations for a driver and the driver's trip is predictable.

4) There is no longstanding pre-arrangement or contract between the driver and the rider. Thus, both parties are able to change their plans. The rider is free to choose to carpool with any driver with a matching trip and the absence of one driver does not cause the rider to be stranded. The driver is able to offer rides to any rider looking for rides and the absence of one rider does not adversely impact the carpool opportunity.

5) One person does not delay the entire group. The rider is free to accept a ride from any driver with a matching trip and the delay of one driver does not cause a delay to the rider. Similarly, the driver is free to offer a ride to any rider at the stops along the way and the delay of one rider does not cause a delay to the driver.

6) The driver is not distracted as there is no need to follow driving directions to unknown locations for pickup or drop-off of riders. Rider pickup and drop-off happens at stops the driver selects in advance and hence the driver knows these stops.

7) The rideshare system stores driver trips as an ordered set of stops and does not require the home address or the work address of the driver or the rider. This removes privacy concerns users have about usage of their home or work address.

8) Drivers and riders do not have to waste time and effort in planning, coordinating and communicating with each other every day. Drivers signal to the rideshare system a few minutes before beginning the trip thus creating a rideshare opportunity, and simply drive to and stop at pre-determined stops. When a ride is needed, riders look for matching driver trips and choose carpools on a first come first served basis.

9) Riders can check if driver trips that can meet their travel requirement are in progress and only choose to go to the rideshare stop if such trips are in progress. Thus there is no wasted effort on the part of a rider where they would go to a rideshare stop but not find any ride.

10) Riders have information about the driver giving riders the control and ability to decide whether they want to travel with the driver or not. Drivers have information about the rider giving drivers control and the ability to accept ride requests or decline ride requests they receive from the rider.

11) Riders and drivers are not subjected to issues such as arbitrary fares, poor condition of vehicle, riders being driven by poor drivers with bad records. The rideshare system provides a standardized experience by having standardized fares, requiring all vehicles to be in good condition, requiring all drivers to have an exemplary driving record, etc.

According to a first clause, a ridesharing system facilitating instant carpooling using a computer aided method comprising the steps of:

Maintaining a database of stops where each stop is a pre-determined place where a transport vehicle can safely stop for a short duration and passengers seeking transportation may assemble and embark or disembark transport vehicles, such that each stop has a unique identity and each stop location is stored in such a format that the distance between two stops in the database can be calculated;

Providing a computer program that allows drivers to register and obtain a unique identity and go through an approval process and allowing only approved drivers to participate in carpooling;

Providing a computer program that allows riders to register and obtain a unique identity and go through an approval process and allowing only approved riders to participate in carpooling;

Utilizing a communications network and computer programs to allow information to be presented to the rider and the driver;

Providing a computer program that allows drivers to create driver trips where each driver trip is represented as an ordered set of stops that is a subset of all stops in the database;

Having the driver indicate through a computer program the intention to start a driver trip a short time prior to the driver starting to travel and subsequently having the driver halt at each stop and in the same sequence as the ordered set of stops representing the driver trip to offer pickup and drop-off to matching riders;

Providing the rider a computer program and having the rider enter the rider trip requirement by entering the origin and destination of the rider trip and providing information to the rider of matching driver trips where the driver has indicated their intention to start a driver trip such that the trip is to start in a short time or the trip is in progress and additionally providing information that includes the estimated trip start time, current location of the vehicle, the set of stops representing the driver trip along with estimated arrival times for each stop, where each driver trip is a match if it has at least one stop within a configured proximity of the origin of the rider and at least one subsequent stop within a configured proximity of the destination of the rider;

Providing the rider a computer program that allows the rider to book their ride on a matching driver trip on a first come first served basis;

Having the rider arrive at a stop and board a vehicle with a matching driver trip if the rider has booked their ride or on a first come first served basis if there are seats available in the vehicle;

Having the rider or driver indicate to the computer program when the rider embarks the vehicle and using the current location to determine the pickup stop of the rider and the current time to determine the pickup time of the rider;

Having the rider or driver indicate to the computer program when the rider disembarks the vehicle and using the current location to determine the drop-off stop of the rider and the current time to determine the drop-off time of the rider;

Charging a fare for the rider using the distance between the pickup stop and the drop-off stop of the rider as a factor and using a variable index based on the location of the rider as another factor;

Having the driver indicate through a computer program the completion of the driver trip;

Providing the driver compensation in proportion to the total fare charged to all the riders during the driver trip.

The method of clause 1 wherein the approval process for the driver may depend on any or all of email address verification, mobile phone number verification, the credit history, the driving history, criminal background check, employment verification, driver's license, the type of vehicle to be used by the driver, the condition and maintenance record of the vehicle to be used by the driver.

The method of clause 1 wherein the approval process for the rider may depend on any or all of email address verification, mobile phone number verification, the credit history, criminal background check and employment verification.

The method of clause 1 wherein, the rideshare stops in the database are stored along with GPS coordinates and using the GPS coordinates of the origin and destination of the rider trip to determine if the driver trip has at least one stop within a configured proximity of the origin and at least one subsequent stop within a configured proximity of the destination for the driver trip to be deemed as a match with the rider trip.

The method of clause 1 wherein, when the driver indicates through a computer program the intention to start the driver trip, the computer program signals matching riders that a driver trip that meets the rider's travel requirement is about to begin or has begun, where each rider is a match if the origin of the rider is within a configured proximity of at least one stop of the driver trip and the destination of the rider is within a configured proximity of at least one subsequent stop of the driver trip and the time difference between the time at which the driver starts the driver trip and the time at which the rider enters the rider trip is within a configured time interval.

The method of clause 1 and providing a computer program wherein, riders purchase ride credits that are used to pay fare for rides taken and drivers collect ride credits based on the rides provided and where the ride credits can be exchanged for tangible goods or money.

The method of clause 1 and the method of maintaining driver ratings wherein, each rider is able to rate the driver at the end of their ride and where such ratings are displayed to potential riders in the future.

The method of clause 1 and the method of maintaining rider ratings wherein, the driver is able to rate each rider at the end of their ride and where such ratings are displayed to potential drivers in the future.

The method of clause 1 and the method of placing an electronic transmitter at each stop that broadcasts the stop information such that computer programs used by the driver and rider detect the transmitter once the computer executing the program enters a configured proximity of the stop, and generating an event upon detection where such an event is used to indicate the driver's arrival at the stop or the rider's presence at the stop.

The method of clause 1 and the method of defining a perimeter around the GPS location of each stop and the method of using the current GPS location in computer programs used by the driver and rider such that the computer programs detect when the computer enters the perimeter of the stop, and generating an event upon detection where such an event is used to indicate the driver's arrival at the stop or the rider's presence at the stop.

The method of clause 1 wherein, the compensation the driver receives for each driver trip is limited to allow cost sharing and prevent the driver from making a profit.

The method of clause 1 wherein riders are issued identification cards that can be read by the computer program used by the driver; and

riders present their identification card to the driver's computer program when they board the vehicle and the current location is used to determine the pickup stop of the rider and the current time is used to determine the pickup time of the rider; and

riders present their identification card to the driver's computer program when they disembark the vehicle and the current location is used to determine the drop-off stop of the rider and the current time is used to determine the drop-off time of the rider.

The method of clause 1 and the method of providing each approved driver a vehicle tag that can be placed in the driver's vehicle that is visible to potential riders from outside the vehicle and where the vehicle tag is used as a visual cue that the driver and the vehicle are approved by the rideshare provider.

The method of clause 1 wherein the rideshare provider provides insurance coverage to the driver and rider such that the coverage applies only if the driver trip is in progress; and

the coverage applies to the rider for the duration of the ride, where the coverage begins at the pickup stop of the rider and the coverage ends at the drop-off stop of the rider; and

the coverage applies to the driver if there is at least one rider in the vehicle who is covered.

The method of clause 1 wherein the computer used by the driver and rider could be a personal device such as a mobile phone or a portable wireless computer.

The method of clause 1 wherein the rideshare system sends tracking notifications to a third party configured by the rider where the third party is notified of each embarkation of the rider along with the driver information, vehicle information, time and location of the pickup, and of each disembarkation of the rider along with the driver information, vehicle information, time and location of the drop-off; and

the rideshare system sends tracking notifications to a third party configured by the driver where the third party is notified when the driver trip starts, and the third party is notified when the driver trip completes and where such notifications include the information of all riders who were provided rides during the trip.

### BRIEF DESCRIPTION OF THE DRAWINGS

FIG. 1 depicts the various components of a rideshare system according to one embodiment of the present disclosure.

FIG. 2 is a diagram of a road network where a number of stops are identified according to one embodiment of the present disclosure.

FIG. 3 is a diagram of a driver trip that is stored in the database as an ordered set of locations according to one embodiment of the present disclosure.

FIG. 4 is a diagram illustrating the progress of a driver trip along a plurality of stops using a rideshare system according to one embodiment of the present disclosure.

FIG. 5a is a flowchart for an application process for a driver to become an approved member in a rideshare system according to one embodiment of the present disclosure.

FIG. 5b is a flowchart for an application process for a rider to become an approved member in a rideshare system according to one embodiment of the present disclosure.

FIG. 6 is a flowchart of a process used for driver trips including the starting of the driver trip, pickup and drop-off of riders along the stops, and the completion of the driver trip according to one embodiment of the present disclosure.

FIG. 7 is a flowchart of a process used by riders to search for driver trips that are about to start or in progress that match their trip requirement according to one embodiment of the present disclosure.

FIG. 8 is a flowchart of a process used for determining insurance coverage for the rider and the driver according to one embodiment of the present disclosure.

### DETAILED DESCRIPTION

A ridesharing system that involves novel methods and apparatus for facilitating instant carpooling is described. Various modifications to the disclosed embodiments will be apparent to those skilled in the art, and the general principles set forth below may be applied to other embodiments and applications.

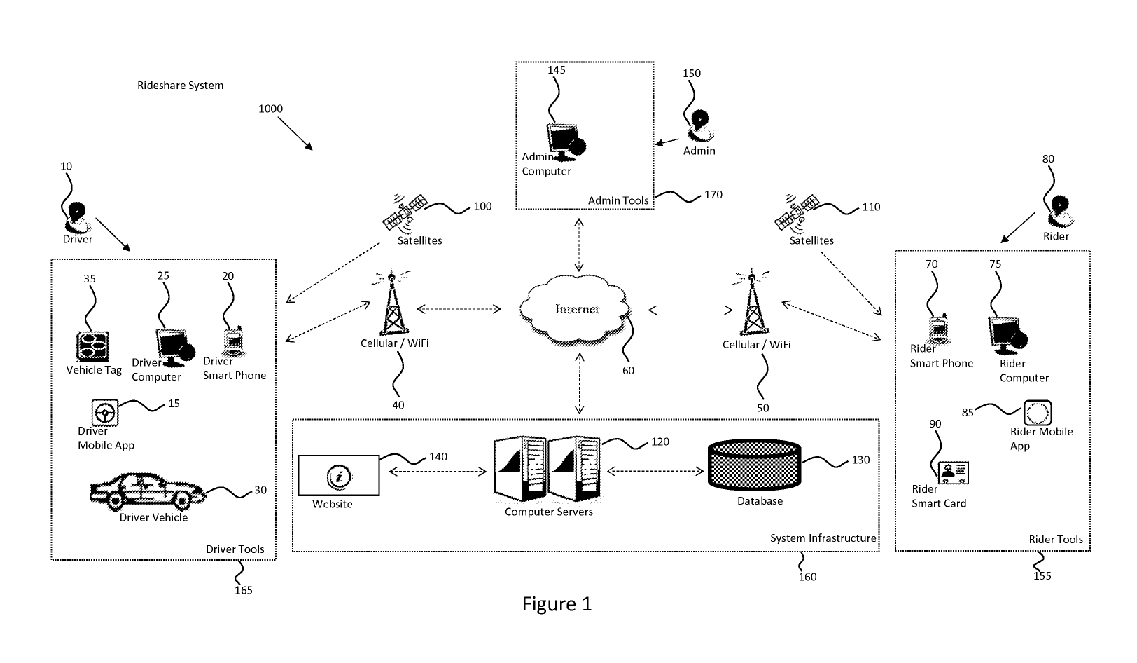

FIG. 1 illustrates an embodiment of a rideshare system comprising a set of tools 165 for a driver 10, which includes a vehicle tag 35, a driver computer 25, a driver mobile device 20 such as a smart phone, a mobile application 15, and a vehicle 30; a set of tools 155 for a rider 80, which includes a rider mobile device 70 such as a smart phone, a rider computer 75, a rider smart card 90, and a rider mobile application 85; a set of tools 170 for the administrator (admin) 150, which includes an administrator computer 145; a set of system infrastructure components 160, which includes a website 140, computer servers 120, and a database 130; and a set of networking components that include a cellular and/or Wi-Fi network 40, a cellular and/or Wi-Fi network 50, and Internet 60.

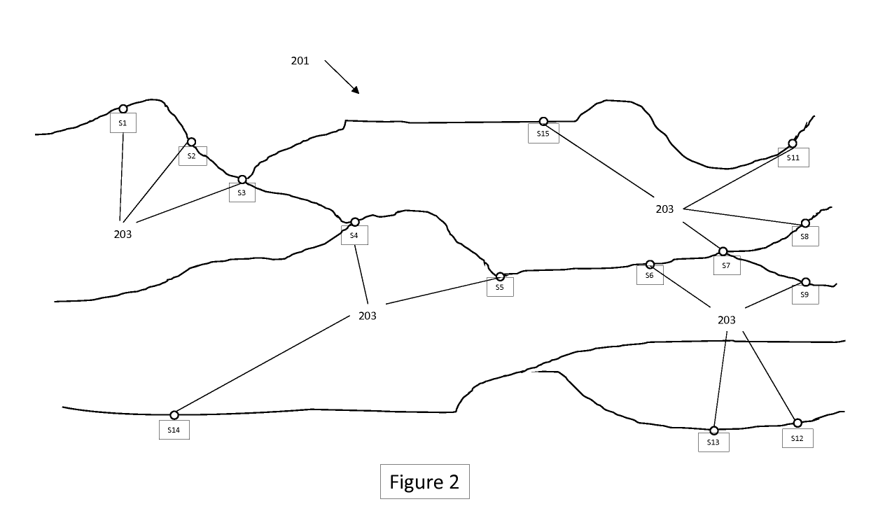

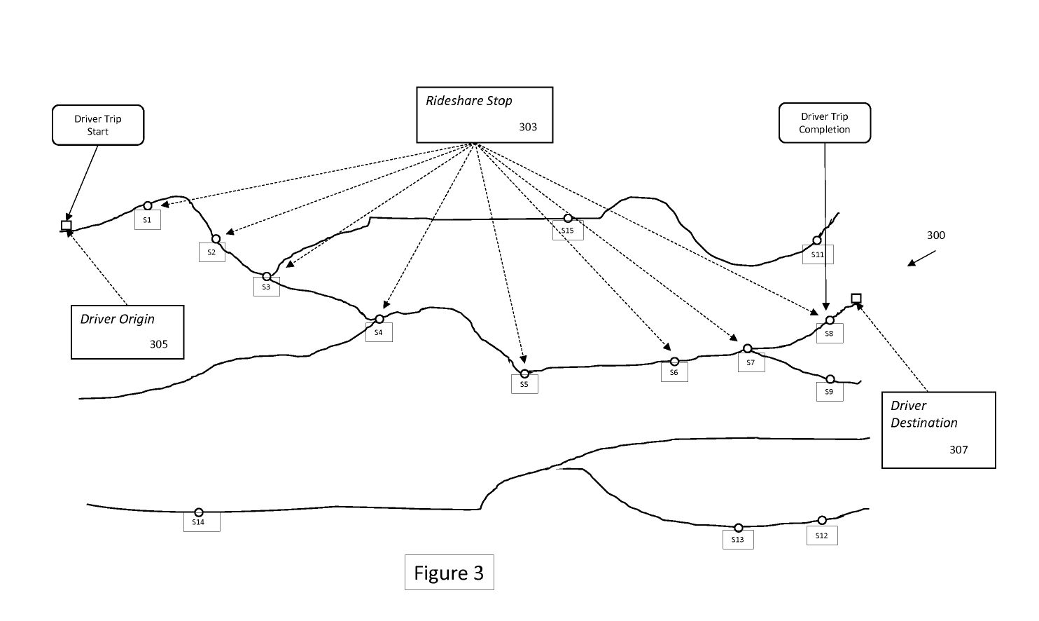

FIG. 2 depicts an embodiment of a sample road network 201 where a number of stops 203 are pre-populated in a rideshare system. These stops may be stored in the database 130 along with their Latitude and Longitude coordinates. FIG. 3 shows a sample driver trip or route 300, which may be stored in the database 130, as the set of locations 303 (shown as the ordered set {S1, S2, S3, S4, S5, S6, S7, S8}). The route 300 begins at the driver origin 305 and completes at the driver destination 307. Riders could board at any of locations S1 through S7 and riders could disembark at any of locations S2 through S8.

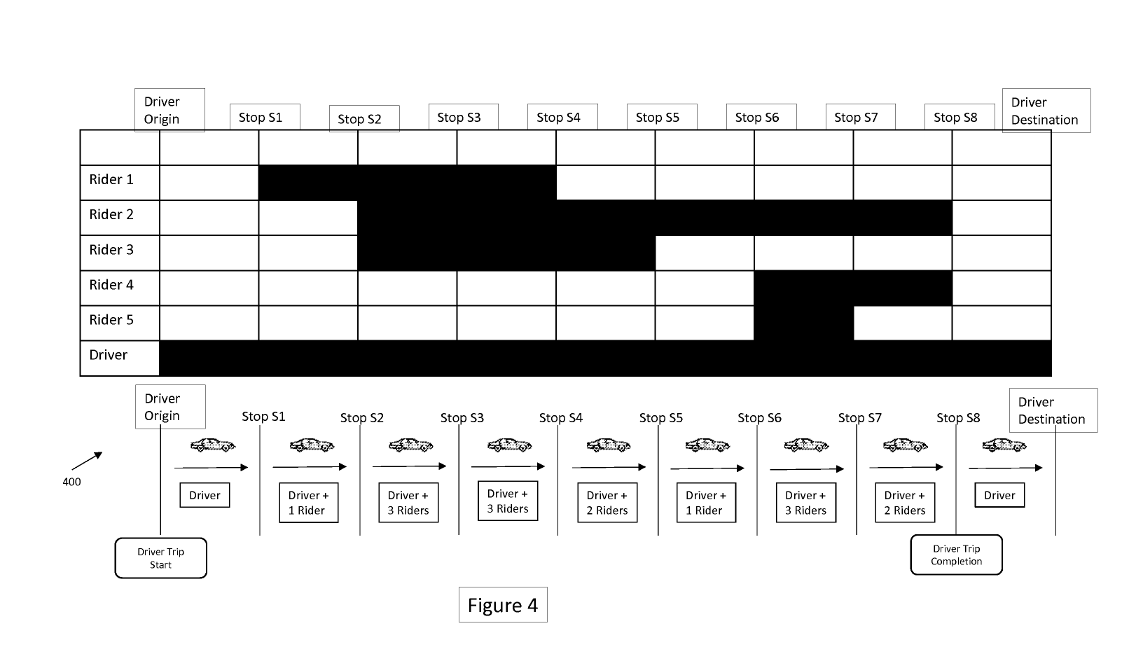

Further, FIG. 4 is a diagram 400 illustrating the progress of a sample driver trip along stops {S1, S2, S3, S4, S5, S6, S7, and S8} according to one embodiment. The driver trip starts at the driver's origin. The driver 10 is the only occupant of the driver vehicle 30 until it reaches the first stop S1. As the driver vehicle 30 moves along the stops, riders board and disembark causing a change in the occupancy of the driver vehicle 30. At the last stop S8, the driver trip completes. After trip completion, the driver 10 is the only occupant of the driver vehicle 30 as it proceeds to the driver's destination.

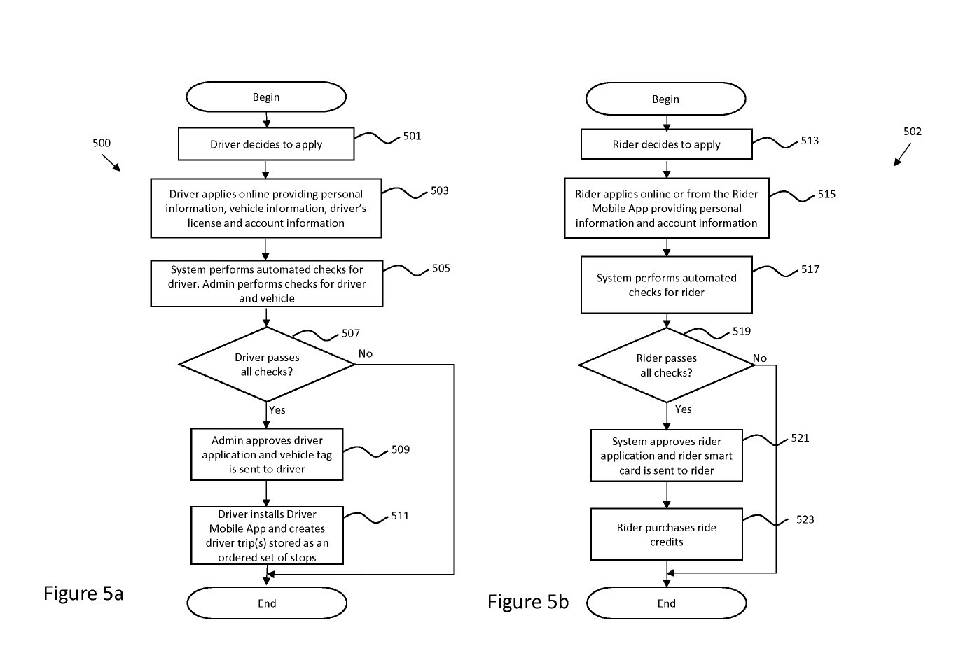

FIGS. 5a and 5b depict embodiments of application processes 500, 502 for drivers and riders, respectively. As shown in FIG. 5a, a driver 10 may apply to become an approved driver in step 501. The driver 10 may visit the website 140 or use the Driver Mobile App 15 and provide information including name, email address, phone number, mailing address, account password, credit card details, driver's license number, insurance coverage, vehicle license plate number, vehicle make, vehicle model, vehicle year, vehicle pictures, condition of the vehicle in step 503. The rideshare system performs automated checks for the driver 10 including email verification, mobile phone number verification in step 505. The admin 150 may use the information provided by the driver 10 to perform additional checks including criminal record check, driving record check, credit history check in step 505. The admin 150 may also check the condition of the vehicle 30 and other vehicle information to ensure the vehicle 30 meets the standard set by the rideshare system for participation in step 505. If the driver 10 passes all checks, the admin 150 approves the driver application and sends the vehicle tag 35 to the driver 10 in step 509. The driver 10 is able to use the Driver Mobile App 15 installed on the driver smart phone 20 to create a driver trip in step 511. The driver 10 enters the route information including origin and destination that are geocoded into Latitude and Longitude coordinates and the Driver Mobile App 15 displays stops in the database 130 that are along the route. The driver 10 is required to select a subset of stops where the driver 10 may pick up or drop-off the rider 80. The stops that the driver 10 selects along with their sequence are stored in the database 130 as the driver trip in step 511.

As shown in FIG. 5b, the rider 80 application process may be different than the driver 10 application process. A rider 80 decides to apply to become an approved rider in step 513. The rider 80 can visit the website 140 or use the Rider Mobile App 85 to provide information required for the rider application including name, email address, phone number, mailing address, account password and credit card details in step 515. The rideshare system performs automated checks for the rider 80 including email verification, mobile phone number verification, criminal record check and credit history check in step 517. If the rider 80 passes all checks in step 519, the rideshare system approves the rider application and issues the rider smart card 90 to the rider 80 in step 521. The rider 80 can now use the website 140 or the Rider Mobile App 85 to purchase ride credits that can be used towards fare payment in step 523.

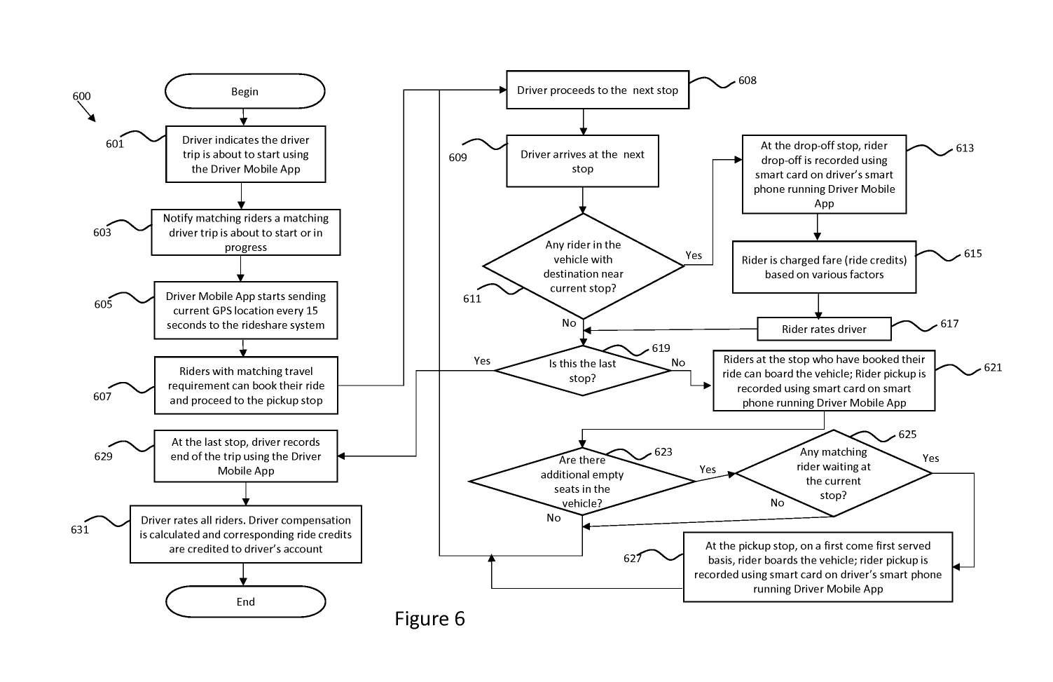

FIG. 6 is a flowchart of an embodiment of a process 600 that may be used for driver trips including the starting of the driver trip, pickup and drop-off of riders along the stops, and the completion of the driver trip. At the time of starting a driver trip, the driver 10 may use the Driver Mobile App 15 to indicate the driver trip is about to start in step 601. According to one embodiment, the driver 10 also puts the vehicle tag 35 in the intended position such that the vehicle tag 35 is visible to riders while they are outside the vehicle 30 and the vehicle tag 35 acts as a means of confirming the vehicle 30 and the driver 10 are approved by the admin 150. The rideshare system may use the driver trip start event to execute a set of program instructions that find out if there are riders who recently searched for rides where the origin of the rider 80 is near a stop that is in the ordered set of stops representing the driver's trip and the destination of the rider 80 is near a subsequent stop that is in the ordered set of stops representing the driver's trip, and sends out notifications to these riders that a driver trip matching their travel needs is about to start or has just begun in step 603. For example, the system may send out notifications to riders with matching origin and destination and who searched in the past fifteen (15) minutes. The Driver Mobile App 15 starts checking the current GPS location periodically, for example every 15 seconds, and sends it to the rideshare system in step 605. A rider 80 seeking a ride can search using the Rider Mobile App 85 and find the driver trip as a match if the origin of the rider 80 is near a stop that is in the ordered set of stops representing the driver's trip and the destination of the rider 80 is near a subsequent stop that is in the ordered set of stops representing the driver's trip. A rider 80 who has found the driver trip as a match can book their ride on that driver trip and make their way to the nearest pickup stop that is in the ordered set of stops representing the driver's trip in step 607.

Once the driver trip or route starts, the process 600 enters a loop starting at step 608. The driver 10 proceeds to the next stop in the set of ordered stops representing the driver trip in step 608. Upon arrival at the next stop in step 609, 611, riders disembarking at the stop record their drop-off using the rider smart card 90 on the driver smart phone 20 running the Driver Mobile App 15 in step 613. The current stop is marked as the drop-off stop for riders who are dropped-off. If the rider's account is configured for sending tracking notifications, the rideshare system sends tracking notifications to third parties configured by the rider 80 that contain information including driver information, vehicle information, time and location of the drop-off. By requiring the rider smart card 90 to be used with the driver smart phone 20 for recording the drop-off, and by using the current location and time from the driver smart phone, the system receives a confirmation from both parties, the rider 80 and the driver 10, about the drop-off location and time. The rider fare is calculated using the distance between the rider's pickup stop and the rider's drop-off stop as a factor and using a variable index based on the location of the rider 80 as another factor and the corresponding ride credits are deducted from the rider's account in step 615. For example, the Composite Index from the Cost of Living Index published by US Census Bureau could be used as the variable location based index.

At the end of the ride, the rider 80 can rate the driver 10 using the Rider Mobile App 85 in step 617. If the current stop is the last stop, the process may exit the loop and goes to step 619 and step 629. If the current stop is not the last stop, the loop continues to step 621. Riders who are at the stop who have booked their ride on that driver trip can board the driver vehicle 30 in step 621. The pickup for riders who board the vehicle 30 is recorded using the rider smart card 90 on the driver smart phone 20 running the Driver Mobile App 15. If there are no additional empty seats in the vehicle 30, the process moves back to the beginning of the loop in step 608. If there are additional empty seats in the vehicle 30, but there are no riders waiting at the current stop to board the vehicle 30, the process moves back to the beginning of the loop at step 608. If there are additional empty seats in the vehicle 30 such that those empty seats would remain unoccupied even if all riders who have booked their ride on that driver trip have boarded the vehicle 30, and there are riders waiting at the current stop to board the vehicle 30, riders board on a first come first served basis depending on the availability of seats. Pickup for riders who board the vehicle 30 is recorded using the rider smart card 90 on the driver smart phone 20 running the Driver Mobile App 15 in step 627. If the rider's account is configured for sending tracking notifications, the rideshare system sends tracking notifications to third parties configured by the rider 80 that contain information including driver information, vehicle information, time and location of the pickup. By requiring the rider smart card 90 to be used with the driver smart phone 20 for recording the pickup, and by using the location and time from the driver smart phone, the system receives a confirmation from both parties, the rider 80 and the driver 10, about the pickup location and time. The current stop is marked as the pickup stop for riders who are picked up. Once all riders have boarded, the driver 10 proceeds to the next stop and the process moves back to the beginning of the loop at in step 608.

At the last stop, after all riders have disembarked the vehicle 30, the driver 10 uses the Driver Mobile App 15 to indicate the completion of the driver trip in step 629. Upon completion of the driver trip, the Driver Mobile App 15 stops checking the current GPS location and stops sending it to the rideshare system. Upon completion of the driver trip, driver compensation is calculated in proportion to the total fare charged to all the riders during the driver trip and the corresponding ride credits are credited to the account of the driver 10 in step 631.

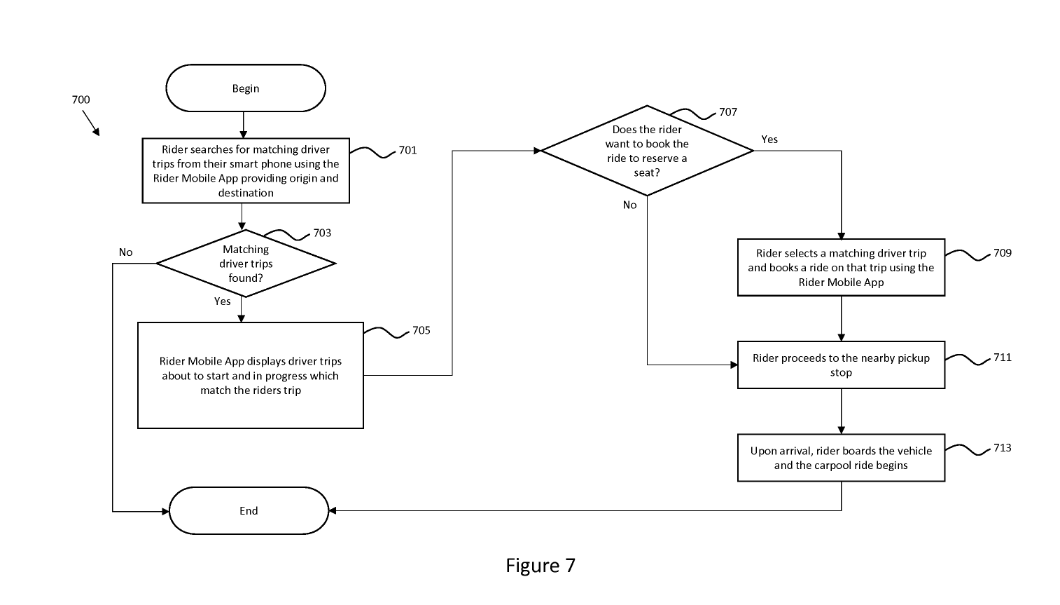

FIG. 7 is a flowchart of a process 700 used by riders to search for driver trips in progress that match their trip requirements. A rider 80 can search for matching driver trips using the Rider Mobile App 85 in step 701. The rider 80 provides the desired origin that may be the current location of the rider 80 and the desired destination. The origin and destination are geocoded into Latitude and Longitude coordinates and the Rider Mobile App 85 requests the rideshare system to search for driver trips that are about to start and those in progress where the driver trip has a stop that is near the origin of the rider 80 and the driver trip has a subsequent stop that is near the destination of the rider 80 in step 703. For example, the rideshare system could return all driver trips that are in progress that have a stop that is within half a mile of the origin of the rider 80 and a subsequent stop that is within half a mile of the destination of the rider 80. If there are no matches, the Rider Mobile App 85 informs the rider 80 and the rider 80 may quit the process or search again at a later time. If matches are found, the Rider Mobile App 85 displays the matched driver trips along with stop information including the nearest stop to the origin in step 705. The rider 80 can choose whether to book the ride on the matched driver trip and thus reserve the seat on a first come, first serve basis or to simply walk up to the stop and board the vehicle with a matching driver trip on a first come, first serve basis in step 707. If the rider 80 chooses to walk up to the stop without booking the ride, the process continues to step 711. If the rider 80 books the ride, the system sends out a notification to the driver 10 informing the driver 10 of the ride that was booked and generates a boarding pass on the rider smart phone 70 that is proof of the ride that was booked in step 709. The rider 80 now has information to proceed to the appropriate stop where the rider 80 can board the vehicle 30 (the pickup stop) in step 711. At the pickup stop, once the vehicle 30 arrives, the rider 80 boards the vehicle 30 and records the pickup using the rider smart card 90 on the driver smart phone 20. If the rider 80 has booked the ride previously, the rider 80 shows the boarding pass to the driver 10 prior to boarding. The driver 10 verifies the boarding pass prior to allowing the rider 80 to board the driver vehicle 30. The carpool ride between the rider 80 and the driver 10 begins in step 713.

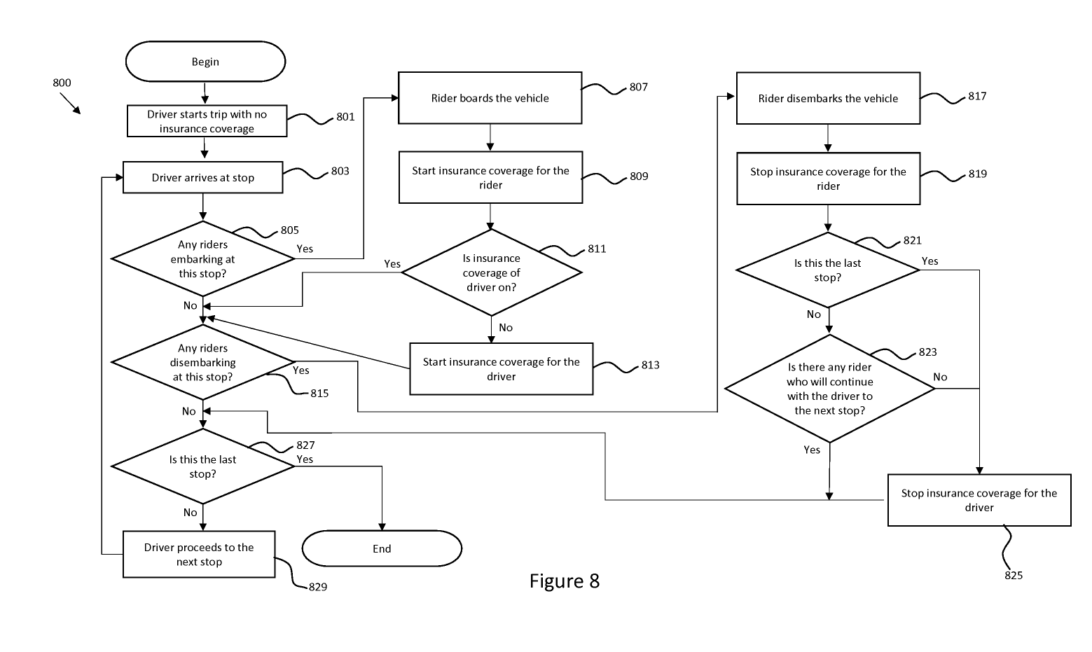

In one embodiment, the rideshare system provides insurance coverage to the riders and drivers engaged in carpooling. FIG. 8 is a flowchart of a process 800 used for determining insurance coverage for the rider and the driver. As shown in FIG. 8, when the driver trip starts and before the driver 10 reaches the first stop, the driver vehicle 30 does not have any riders in it and the process starts with no insurance coverage for the rider 80 and driver 10 in step 801. Once the driver trip starts, the process enters a loop starting in step 803. The driver 10 arrives at a stop of the driver trip in step 803 it is determined if any riders are embarking at this stop in step 805. Riders with matching trip requirements may board the driver vehicle 30 at the current stop in step 807. The insurance coverage for the rider 80 starts from their pickup stop in step 809. If the driver insurance coverage has not yet started, then the driver insurance coverage begins at the same time the rider insurance coverage begins for a rider in the driver vehicle 30 in step 811, 813. If there are one or more riders disembarking the vehicle 30 at the current stop in step 815, each rider 80 disembarks the vehicle 30 in step 817. The insurance coverage for the rider 80 stops at their drop-off stop in step 819. If this is the last stop in step 821, the driver's insurance coverage stops in step 825 and the process ends. If this is not the last stop, the process continues to step 823. If there are no riders who will continue to ride with the driver 10 to the next stop, the driver's insurance coverage is stopped at the current stop in step 825. If there are one or more riders who will continue to ride with the driver 10 to the next stop in step 823, the driver's insurance coverage continues. If it is determined that there are more stops remaining in step 827, the driver 10 proceeds to the next stop in step 829 and the loop repeats beginning in step 803.

In one embodiment, the rider smart card 90 issued to the rider 80 uses a technology such as barcode, magnetic stripe, Near Field Communications (NFC) or the identification card may be an electronic device using a protocol such as Bluetooth or RFID.

In one embodiment, rider pickup and drop-off information is recorded by the driver 10 on the driver smart phone 20 using the Driver Mobile App 15. Riders who are at the stop who have booked their ride on that driver trip can board the vehicle in step 621. The pickup for riders who board the vehicle 30 is recorded by the driver 10 on the driver smart phone 20 using the Driver Mobile App 15. The disembarkation of riders at the stop is recorded as their drop-off by the driver 10 on the driver smart phone 20 running the Driver Mobile App 15 in step 613.

In one embodiment, electronic transmitters are placed at each stop and these transmitters broadcast stop information. When the driver vehicle 30 and hence the driver smart phone 20 running the Driver Mobile App 15 enters a specific proximity range of the stop, the Driver Mobile App 15 will detect the transmitter and generate an event, where such an event is used to indicate the driver's arrival at the stop. The current stop identified using the electronic transmitter is assigned as the pickup stop and the drop-off stop to pickups and drop-offs that happen at that location. When the rider 80 and hence the rider smart phone 70 running the Rider Mobile App 85 enters a specific proximity range of the stop, the Rider Mobile App 85 will detect the transmitter and generate an event, where the event is used to indicate the rider's arrival at the stop.

In one embodiment, a perimeter around the GPS location of each stop is defined. The driver smart phone 20 running the Driver Mobile App 15 monitors the GPS location of the driver periodically. When the driver vehicle 30 and hence the driver smart phone 20 running the Driver Mobile App 15 enters the perimeter of the stop, the driver's device generates an event where the event is used to announce the driver's arrival at the stop. The current stop identified using the perimeter method may be assigned as the pickup stop and the drop-off stop to pickups and drop-offs that happen at that location. The rider smart phone 70 running the Rider Mobile App 85 monitors the GPS location of the rider periodically. When the rider 80, and hence the rider smart phone 70 running the Rider Mobile App 85, enters the perimeter of the stop, the Rider Mobile App 85 generates an event, where the event is used to announce the rider's arrival at the stop.

In one embodiment, the compensation the driver 10 receives is limited to allow cost sharing and prevent the driver 10 from making a profit. A rate that represents the cost of driving a personal vehicle is used along with the distance of the driver trip to limit the compensation the driver 10 receives. For example, the rate for the average costs per mile for a medium sedan published by American Automobile Association (AAA) in the publication “Your Driving Costs 2013” could be used.

Organizations such as employers and public agencies promote carpooling by providing incentives to carpoolers. Presently, the methods employed by these organizations require individuals to indicate their carpool trips electronically or on paper. These methods are based on good faith and the organizations do not have a way to verify if the carpool trips indicated by the individuals actually occurred. In one embodiment, the rides taken by the rider 80 where the pickup stop and the drop-off stop of the rides were assigned using GPS coordinates of the rider 80 and where the rider 80 was provided a ride by a driver 10 and was charged a fare are considered verified carpool trips and incentives are provided to the rider 80 based on those verified carpool trips. The driver trips in which rides were provided to riders where the pickup stop and the drop-off stop of such rides were assigned using GPS coordinates of the riders and where the driver 10 was compensated are considered verified carpool trips and incentives are provided to the driver 10 based on those verified carpool trips.

It will be appreciated that embodiments of the method and system of the present disclosure may alternatively be implemented by software programs controlling a programmable computer, or by hardware-based integrated circuit devices, including microprocessors and permanent instructions containing memories. Additionally, as would be appreciated by someone skilled in the relevant art(s) and described below with reference to FIGS. 1-8, part or all of one or more aspects of the methods and system discussed herein may be distributed as an article of manufacture that itself comprises a computer readable medium having computer readable code means embodied thereon.

As described herein, software stored in a memory device may include an ordered listing of executable instructions for implementing logical functions (i.e., “logic” that may be implement either in digital form such as digital circuitry or source code or in analog form such as analog circuitry or an analog source such an analog electrical, sound or video signal), may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples “a non-exhaustive list” of the computer-readable medium would include the following: an electrical connection “electronic” having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

A mobile device as referred to herein may be implemented as a handheld portable device, computer, mobile telephone, sometimes referred to as a smartphone, tablet personal computer (PC), laptop computer, or any combination thereof. Non-limiting examples of smartphones include, for example, Palm® products such as Palm® Treo® smartphones (now Hewlett Packard or HP), Blackberry® smart phones, Apple® iPhone®, Motorola Droid®, and the like. Tablet devices include the iPad® tablet computer by Apple® and more generally a class of lightweight portable computers known as Netbooks. In some embodiments, the mobile device may be comprise, or be implemented as, any type of wireless device, mobile station, or portable computing device with a self-contained power source (e.g., battery) such as a laptop computer, ultra-laptop computer, personal digital assistant (PDA) with communications capabilities, cellular telephone, combination cellular telephone/PDA, mobile unit, subscriber station, user terminal, portable computer, handheld computer, palmtop computer, wearable computer, media player, pager, messaging device, data communication device, and so forth. Further, while described with reference to a mobile device or computer with regard to FIG. 1, the functions described herein may be implemented in any other device as appropriate.

The computer readable program code means is operable, in conjunction with a computer system, to carry out all or some of the steps to perform the methods or create the system discussed herein. The computer readable medium may be a recordable medium (e.g., hard drives, compact disks, EPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer devices, systems, and servers described herein each contain a memory that will configure associated processors to implement the methods, steps, and functions disclosed herein. Such methods, steps, and functions can be carried out, e.g., by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the terms “memory”, “memory storage”, “memory device”, or similar terms should be construed broadly enough to encompass any information able to be read from or written to an address in the addressable space accessed by an associated processor.

Aspects of the present disclosure discussed with regards to and shown in FIGS. 1-8, or any part(s) or function(s) thereof as appropriate, may be implemented using hardware, software modules, firmware, tangible computer readable media having instructions stored thereon, or a combination thereof and may be implemented in one or more computer systems or other processing systems.

The various illustrative functional elements, logical blocks, modules, circuits, and processors described in connection with the embodiments disclosed herein may be implemented or performed with an appropriate processor device, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein as appropriate. As described herein a processor may be a microprocessor, but in the alternative, the processor may be any conventional processor, controller, microcontroller, or state machine designed to perform the appropriate function. A processor may be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format.

The functions of the various functional elements, logical blocks, modules, and circuits elements described in connection with the embodiments disclosed herein may be performed through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the terms “processor” or “module” should not be construed to refer exclusively to hardware capable of executing software, and may implicitly include, without limitation, DSP hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The various functional elements, logical blocks, modules, and circuits elements described in connection with the embodiments disclosed herein may comprise a processing unit for executing software program instructions to provide computing and processing operations for the systems and methods described herein. A processing unit may be responsible for performing various voice and data communications operations between the mobile device and other components of an appropriate system. Although the processing unit may include a single processor architecture, it may be appreciated that any suitable processor architecture and/or any suitable number of processors in accordance with the described embodiments. In one embodiment, the processing unit may be implemented using a single integrated processor.

The functions of the various functional elements, logical blocks, modules, and circuits elements described in connection with the embodiments disclosed herein may also be implemented in the general context of computer executable instructions, such as software, control modules, logic, and/or logic modules executed by the processing unit. Generally, software, control modules, logic, and/or logic modules include any software element arranged to perform particular operations. Software, control modules, logic, and/or logic modules can include routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the example aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or example language (e.g., “such as”, “in the case”, “by way of example”) provided herein is intended merely to better illuminate the present disclosure and does not pose a limitation on the scope of the present disclosure otherwise claimed. No language in the specification should be construed as indicating any non-claimed element essential to the practice of the present disclosure. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

It is to be understood that the disclosed embodiments of the present disclosure are by no means limited to the particular apparatus and steps herein disclosed and/or shown in the drawings, but also comprise any modifications or equivalents within the scope of the claims.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments and appended claims.

Components and Terminology:

Driver Mobile App—The Driver Mobile App 15 may be a piece of software that may be installed by drivers on their personal device such as a smart phone or a tablet computer.

Rider Mobile App—The Rider Mobile App 85 may be a piece of software that may be installed by riders on their personal device such as a smart phone or a tablet computer.

Driver Smart Phone—The driver smart phone 20 may be a phone or a personal device that can also be used as a computer to install and run software programs. In one embodiment, the driver smart phone runs the Driver Mobile App 15 when the driver trip is in progress. In one embodiment, the driver smart phone may meet requirements specified by the rideshare system such as GPS location capability, the ability to transmit data via cellular network or WiFi. Examples of Driver Smart Phone may include Android devices such as Galaxy Nexus by Samsung, Samsung S4, Samsung Galaxy Note, Apple devices such as the iPhone 5S, iPhone 5C, iPad and Windows devices such as the Nokia Lumia.

Rider Smart Phone—The rider smart phone 70 may be a phone that can also be used as a computer to install and run software programs. In one embodiment, the Rider Smart Phone runs the Rider Mobile App 85. In one embodiment, the Rider Smart Phone may meet requirements specified by the rideshare system such as GPS location capability, the ability to transmit data via cellular network or WiFi. Examples of Rider Smart Phone may include Android devices such as Galaxy Nexus by Samsung, Samsung S4, Samsung Galaxy Note, Apple devices such as the iPhone 5S, iPhone 5C, iPad and Windows devices such as the Nokia Lumia.

Rider Smart Card—The rider smart card 90 may be an identification card that contains a unique identity for each rider. For example, the rider smart card may use technology such as Radio-Frequency Identification (RFID) or barcode. In one embodiment, the rider smart card may also be in a digital format stored in an electronic device such as a smart phone.

GPS—As discussed herein, the Global Positioning System (GPS) is a satellite-based navigation system made up of a network of 24 satellites placed into orbit by the U.S. Department of Defense.

Android—Android is an operating system based on the Linux kernel primarily for touchscreen mobile devices such as smartphones and tablet computers maintained by Google Inc.

iOS—iOS is a mobile operating system developed and distributed by Apple Inc.

Vehicle Tag—The vehicle tag 35 may be a visible object that can be placed in or outside the vehicle and that is visible to potential riders from outside the vehicle. For example, the vehicle tag could be a sticker placed on the windshield.

What is claimed is:

1. A method of ridesharing to facilitate instant carpooling comprising:
registering a first party with a ridesharing service;
providing a unique identity to the first party upon the first party meeting an approval process;
receiving, from the first party, information regarding a first route, wherein the first route comprises a plurality of first locations along a first path to be traveled in a first direction by a vehicle;
receiving, from a second party, information regarding a second route, wherein the second route comprises a second location and a third location along a second path to be traveled in a second direction by a vehicle;
receiving, from the first party, a first communication indicating that the first party is embarking within a predetermined amount of time to travel along the first route;
upon receiving the first communication from the first party, determining, via a processor, whether the first route and the second route match;
upon determining that the first route of the first party and the second route of the second party match, sending a second communication.

2. The method of claim 1, further comprising receiving a confirmation communication from the second party, wherein the confirmation communication comprises an acknowledgement from the second party that it will accept a ride from the first party.

3. The method of claim 1, wherein the approval process of the first party may depend on at least one of a credit history of the first party, a driving history of the first party, criminal background check of the first party, an employment verification of the first party, a driver's license of the first party, a type of vehicle to be used by the first party, a condition and maintenance record of a vehicle to be used by the first party.

4. The method of claim 1, wherein the unique identity is a first unique identity, wherein the approval process is a first approval process, the method further comprising registering the second party with the ridesharing service, and providing a second unique identity to the second party upon the second party meeting a second approval process.

5. The method of claim 4, wherein the second approval process for the second party may depend on at least one of an email verification of the second party, a mobile phone number verification of the second party, a credit history of the second party, a criminal background check of the second party, and an employment verification of the second party.

6. The method of claim 1, wherein the information regarding the first route is stored in a format such that a distance of the first path or a distance of a portion of the first path can be calculated.

7. The method of claim 1, wherein the first plurality of locations of the first route comprise an ordered set of locations that are stored in a database.

8. The method of claim 7, wherein receiving information regarding the first route from the first party comprises receiving a selection of the plurality of first locations from the database.

9. The method of claim 1, further comprising providing compensation to the first party based on a fare charged to the second party.

10. The method of claim 9, wherein the fare is determined based on a distance between the second location and the third location of the second route and a variable index based on a current location of the second party.

11. The method of claim 9, wherein the compensation provided to the first party is limited so as to not exceed a predetermined amount and thereby allowing cost sharing between the first party and the second party and preventing the first party from receiving a profit.

12. The method of claim 1, further comprising storing the information regarding the second route in a database.

13. The method of claim 1, wherein determining whether the first route of the first party and the second route of the second party match comprises determining if at least one of the second location and the third location is within a predetermined proximity of at least one of the plurality of first locations.

14. The method of claim 1, further comprising receiving from the first party an indication of a time when the first party embarks to travel along the first route.

15. The method of claim 14, wherein the indication further comprises a current location of the first party.

16. The method of claim 1, further comprising providing an estimate of a time when the vehicle of the first party will reach each of the plurality of first locations along the first path.

17. The method of claim 1, further comprising receiving an indication of a time when the second party embarks in a vehicle of the first party.

18. The method of claim 17, wherein receiving the indication of the time when the second party embarks comprises receiving the indication from the first party.

19. The method of claim 17, wherein the indication further comprises a current location of the second party and the further comprising determining a location of the plurality of first locations that is the closest to the current location of the second party.

20. The method of claim 1, further comprising receiving an indication of a time when the second party disembarks from a vehicle of the first party.

21. The method of claim 20, wherein receiving the indication of the time when the second party disembarks comprises receiving the indication from the first party.

22. The method of claim 20, wherein the indication further comprises a current location of the second party and the further comprising determining a location of the plurality of first locations that is the closest to the current location of the second party.

23. The method of claim 1, further comprising receiving, from a third party, information regarding a third route, wherein the third route comprises a fourth location and a fifth along a third path to be traveled in a third direction by a vehicle;
determining whether the first route and the third route match;
upon determining that the second route and the third route both match the first route, determining a priority between the third party and the second party;
upon determining the priority between the third party and the second party, sending the communication comprises sending the communication to the second party or the third party based on the determined priority.

24. The method of claim 23, wherein determining a priority between the third party and the second party comprises determining whether the information regarding the second route was received before the information regarding the third route.

25. The method of claim 1, further comprising receiving, from the first party, a destination confirmation communication, wherein the destination confirmation communication comprises an acknowledgement from the first party that it has reached an end of the first route.

26. The method of claim 1, wherein the second location is a beginning location of the second route and the third location is an end location of the second route, and wherein determining whether the first route of the first party and the second route of the second party match comprises determining if the beginning location and the end location match any of the plurality of first locations.

27. The method of claim 26, further comprising receiving, from the second party, a desired departure time.

28. The method of claim 27, wherein determining whether the first route of the first party and the second route of the second party match further comprises determining if the beginning location of the second party is within a configured proximity of at least one of the plurality of locations of the first route and a time difference between a first time at which the first party begins traveling the first route and the departure time is within a predetermined time interval.

29. The method of claim 1, and the method of placing an electronic signal transmitter at each first location of the plurality of first locations such that when the mobile device associated with the first party or the second party is within a predetermined distance of the first location, the mobile device receives the signal from the transmitter and generates a proximity communication.

30. The method of claim 1, further comprising receiving, from the second party, rating information associated with the first party and receiving, from the first party, rating information associated with the second party and displaying the rating information associated with the first party and the second party.
